(19) United States
(12) Patent Application Publication
(10) Pub. No.: US 2024/0328932 A1
(43) Pub. Date: Oct. 3, 2024

(54) SPECTROPHOTOMETER

(71) Applicant: SHIMADZU CORPORATION, Kyoto (JP)

(72) Inventor: Masato WATANABE, Kyoto (JP)

(73) Assignee: SHIMADZU CORPORATION, Kyoto (JP)

(21) Appl. No.: 18/614,653

(22) Filed: Mar. 23, 2024

(30) Foreign Application Priority Data
Mar. 31, 2023 (JP) 2023-057134

(51) Int. Cl. G01N 21/31

(52) U.S. Cl. CPC G01N 21/31

(57) ABSTRACT

Provided are a light source (2) that emits light to be applied to a sample, a spectroscopic element (12) that disperses the light from the sample for each wavelength; and a light receiver (14) in which light receiving elements for detecting light of each wavelength dispersed by the spectroscopic element (12) are arranged, the light receiver (14) having a surface in direct with a filter layer (16) that shields high-order diffracted light from the spectroscopic element.

### BACKGROUND OF THE INVENTION

### 1. Field of the Invention

The present invention relates to a spectrophotometer used as a detector in an analyzer such as a liquid chromatograph.

### 2. Description of the Related Art

There is a spectrophotometer as a detector of an analyzer such as a liquid chromatograph. Some spectrophotometers can acquire spectrum information on a sample in real time (see WO 2018/193572 A). Such a spectrophotometer irradiates a sample with light from a light source, disperses transmitted light or scattered light of the sample for each wavelength by a spectroscopic element such as a diffraction grating or a prism, and detects the dispersed light of each wavelength by a light receiver such as a photodiode array (PDA) or a charge coupling device (CCD), thereby measuring an intensity distribution (wavelength spectrum) for each wavelength.

The spectrophotometer described above is adjusted to cause light of a predetermined wavelength to be incident on each of a plurality of light receiving elements provided in the light receiver, and may cause a problem that high-order diffracted light of a certain wavelength generated in a diffraction grating is incident on a light receiving element configured to receive another wavelength, depending on a measurement wavelength range, when a diffraction grating is used as the spectroscopic element, thereby deteriorating measurement accuracy. Thus, a quartz glass window plate provided on its surface with a filter that shields high-order diffracted light is typically disposed between the spectroscopic element and the light receiver, as a countermeasure.

### SUMMARY OF THE INVENTION

When a quartz glass window plate provided on its surface with a filter is disposed between a spectroscopic element and a light receiver, light is reflected multiple times between the light receiver and the quartz glass window plate, and thus causing a problem that the light is incident on another light receiving element different from a light receiving element on which the light is originally to be incident, thereby deteriorating measurement accuracy.

Thus, WO 2018/193572 A proposes adjustment of a positional relationship between a spectroscopic element and a light receiver to prevent light from being re-incident on an adjacent light receiving element, the light being reflected multiple times between a light receiving element that receives light in a specific wavelength range (200 nm to 300 nm) and a window plate. This configuration suppresses influence of multiple reflection of light between the light receiving element and the window plate within the specific wavelength range. However, even when the positional relationship between the spectroscopic element and the light receiver is adjusted as described above, a wavelength range other than the specific wavelength range is affected by the multiple reflection. Additionally, it has been found that a component scattered at a wide angle on the surface of the light receiving element exists even within the specific wavelength range, and such a scattered component is re-reflected by the window plate to adversely affect measurement accuracy.

Thus, an object of the present invention is to eliminate influence of multiple reflection of light between a light receiver and a window plate while preventing deterioration of measurement accuracy due to high-order diffracted light.

A spectrophotometer according to the present invention includes: a light source that emits light to be applied to a sample; a spectroscopic element that disperses the light from the sample for each wavelength; and a light receiver in which light receiving elements for detecting light of each wavelength dispersed by the spectroscopic element are arranged, the light receiver having a surface in direct with a filter layer that shields high-order diffracted light from the spectroscopic element.

The spectrophotometer according to the present invention causes the surface of the light receiver to be in direct contact with the filter layer that shields high-order diffracted light from the spectroscopic element, and thus enables not only preventing deterioration of measurement accuracy due to high-order diffracted light, but also preventing multiple reflection of light between the light receiver and the window plate from occurring because a quartz glass window plate is not required to be disposed between the spectroscopic element and the light receiver.

### BRIEF DESCRIPTION OF THE DRAWINGS

FIG. 1 is a schematic configuration diagram illustrating a spectrophotometer according to an embodiment;

FIG. 2 is a side view of a light receiver for illustrating an example of a structure of a filter layer according to the embodiment;

FIG. 3 is a side view of a light receiver for illustrating another example of the structure of the filter layer of the embodiment; and

FIG. 4 is a sectional view for illustrating an example of a surface shape of a filter layer.

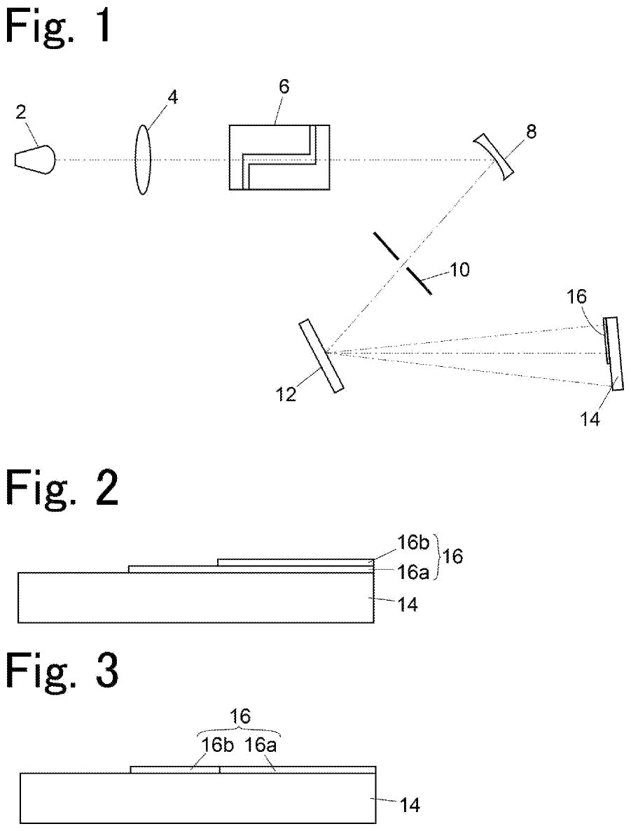

### DETAILED DESCRIPTION OF THE INVENTION

Hereinafter, an embodiment of a spectrophotometer according to the present invention will be described with reference to the drawings.

The spectrophotometer of the present embodiment includes a light source 2, a condenser lens 4, a flow cell 6, a mirror 8, an inlet slit 10, a diffraction grating 12 (spectroscopic element), and a light receiver 14.

The condenser lens 4 and the flow cell 6 are disposed on an optical path of light emitted by the light source 2, and the flow cell 6 is irradiated with the light from the light source 2 through the condenser lens 4. Eluate from a separation column of a liquid chromatograph flows in the flow cell 6.

The mirror 8 is disposed to reflect the light transmitted through the flow cell 6 and guide the light toward the inlet slit 10, and the light having passed through the inlet slit 10 is guided to the spectroscopic element 12 such as a diffraction grating. The light guided to the spectroscopic element 12 is dispersed into light of each wavelength component and guided to the light receiver 14.

The light receiver 14 includes a plurality of light receiving elements arranged in respective spectral directions of light to receive light of corresponding wavelength components dispersed by the spectroscopic element 12. The light receiver 14 is a photodiode array, for example. The light receiver 14 has a light receiving surface in direct contact with a filter layer 16. The filter layer 16 shields high-order diffracted light from the spectroscopic element 12 to prevent incidence of the light on the light receiving elements of the light receiver 14.

As illustrated in FIG. 2, the filter layer 16 on the light receiving surface of the light receiver 14 in the present embodiment includes a first filter layer 16a and a second filter layer 16b. The first filter layer 16a is formed directly on the light receiving surface of the light receiver 14, and the second filter layer 16b is formed on the first filter layer 16a.

The first filter layer 16a is evaporated on a light receiving surface of a light receiving element for receiving light having a wavelength of 320 nm or more among the light receiving elements of the light receiver 14. The first filter layer 16a has a light transmittance of 80% or more for light having a wavelength of 320 nm or more, and a light transmittance of 0.04% or less for light having a wavelength of less than 270 nm (a range from 270 nm to 320 nm is a transient region), for example. As a result, the second-order diffracted light and the third-order diffracted light having a wavelength of less than 270 nm are prevented from being incident on the light receiving elements of the light receiver 14.

The second filter layer 16b is evaporated on the first filter layer 16a to cover a light receiving surface of a light receiving element for receiving light having a wavelength of 480 nm or more among the light receiving elements of the light receiver 14. The second filter layer 16b has a light transmittance of 80% or more for light having a wavelength of 480 nm or more, and a light transmittance of 0.04% or less for light having a wavelength of less than 420 nm (a range from 420 nm to 480 nm is a transient region), for example. As a result, the second-order diffracted light having a wavelength of less than 420 nm is prevented from being incident on the light receiving elements of the light receiver 14.

As described above, the filter layer 16 including the first filter layer 16a and the second filter layer 16b is in direct contact with the light receiving surface of the light receiver 14, and has no gap from the light receiving surface of the light receiver 14. This configuration does not require a quartz glass window plate for holding a filter for shielding high-order diffracted light to be disposed between the spectroscopic element 12 and the light receiver 14. As a result, influence on measurement accuracy due to multiple reflection of light between the light receiver 14 and the window plate is eliminated.

Light reflected by the light receiving surface of the light receiver 14 is re-reflected at an interface between the first filter layer 16a and an air layer, an interface between the first filter layer 16a and the second filter layer 16b, and an interface between the second filter layer 16b and the air layer, so that the light may be reflected multiple times. However, each of the filter layers 16a and 16b has a very small film thickness (e.g., 10 μm or less), so that the re-reflected light is incident at a position that is not greatly deviated from a position where the light is first reflected. Thus, the re-reflected light is less likely to be incident on a light receiving element provided at a position away from the light receiving element on which the re-reflected light is to be originally incident. Thus, providing the filter layer 16 in direct contact with the light receiving surface of the light receiver 14 enables influence of multiple reflection of light on spectrum measurement accuracy to be greatly reduced as compared with when a window plate is provided between the spectroscopic element 12 and the light receiver 14.

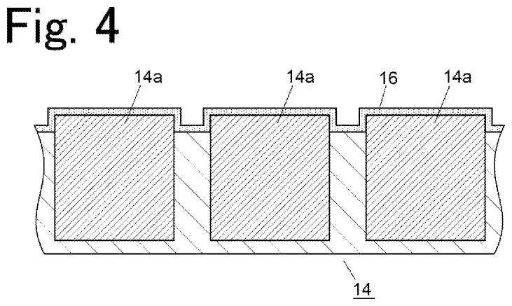

The light receiving surface of the light receiver 14 in the present embodiment includes a receiving surface of a light receiving element for receiving light having a wavelength of less than 320 nm, the receiving surface including no filter layer. When the filter layer 16 is formed, a region requiring no filter layer 16, or the region on which no high-order diffracted light is incident, is masked to prevent a filter layer from being formed as described above, thereby enabling the filter layer 16 to be formed only on a region on which the high-order diffracted light is incident and thus the filter layer 16 is required. Although FIG. 2 illustrates an example in which the filter layer 16b is formed on the filter layer 16a, the filter layer 16b can also be directly evaporated on the light receiving surface of the light receiver 14 as illustrated in FIG. 3, and then an effect equivalent to that of the structure of FIG. 2 can be obtained.

When the filter layer 16 is formed along the light receiving surface of the light receiver 14 as illustrated in FIG. 4, the filter 16 has a surface in a shape reflecting a shape of the light receiving surface of the light receiver 14. FIG. 4 illustrates an example in which the light receiving elements 14a of the light receiver 14 are arranged with a gap therebetween, and a recess exists between light receiving surfaces of the light receiving elements 14a adjacent to each other. Thus, the surface shape of the filter layer 16 is also an uneven shape reflecting an uneven shape of the light receiving surface of the light receiver 14. Such a structure is formed because the filter layer 16 is directly formed on the surface of the light receiver 14, and is clearly different from a structure in which a quartz glass window plate provided on its surface with a filter is simply attached to the light receiving surface of the light receiver 14.

The examples described above are merely examples of the spectrophotometer according to embodiments of the present invention. The spectrophotometer according to the embodiments of the present invention is as follows.

The spectrophotometer according to an embodiment of the present invention includes: a light source that emits light to be applied to a sample; a spectroscopic element that disperses the light from the sample for each wavelength; and a light receiver in which light receiving elements for detecting light of each wavelength dispersed by the spectroscopic element are arranged, the light receiver having a surface in direct with a filter layer that shields high-order diffracted light from the spectroscopic element.

An aspect [1] of the embodiment includes the filter layer evaporated on the surface of the light receiver.

An aspect [2] of the embodiment includes the filter layer having a surface in a shape reflecting a surface shape of the light receiver. This aspect [2] can be combined with the above aspect [1].

### DESCRIPTION OF REFERENCE SIGNS

2 light source
4 lens
6 flow cell
8 mirror
10 slit
12 spectroscopic element
14 light receiver
16 filter layer

What is claimed is:

1. A spectrophotometer comprising:
a light source that emits light to be applied to a sample;
a spectroscopic element that disperses the light from the sample for each wavelength; and
a light receiver in which light receiving elements for detecting light of each wavelength dispersed by the spectroscopic element are arranged,
the light receiver having a surface in direct with a filter layer that shields high-order diffracted light from the spectroscopic element.

2. The spectrophotometer according to claim 1, wherein the filter layer is evaporated on a surface of the light receiver.

3. The spectrophotometer according to claim 1, wherein the filter layer has a surface in a shape reflecting a surface shape of the light receiver.
